(19) United States
(12) Patent Application Publication
(10) Pub. No.: US 2015/0075822 A1
(43) Pub. Date: Mar. 19, 2015

(54) ENGINE COMPARTMENT FIRE SUPPRESSION SYSTEM

(71) Applicant: FORD GLOBAL TECHNOLOGIES, LLC, DEARBORN, MI (US)

(72) Inventors: Paul Bryan Hoke, Plymouth, MI (US); Manfred Koberstein, Troy, MI (US); Kenneth J. Jackson, Dearborn, MI (US); Steven L. Lambert, Washington, MI (US); Steven Van Buren Lake, Manchester, MI (US)

(21) Appl. No.: 14/030,178

(22) Filed: Sep. 18, 2013

(51) Int. Cl. A62C 3/07; A62C 99/00; A62C 37/36

(52) U.S. Cl. CPC A62C 3/07; A62C 37/36; A62C 99/0018
USPC 169/46; 169/61

(57) ABSTRACT

An engine compartment fire suppression system for an HVAC system of a vehicle monitors conditions including, but not limited to, a collision sensor, an air conditioning system pressure sensor, engine coolant temperature, exhaust gas temperature, or an engine load calculation. The fire suppression system discharges a fire suppression composition when a controller receives a specified combination of the monitored conditions.

### TECHNICAL FIELD

This disclosure relates to a system that discharges a fire suppression material in the engine compartment of a vehicle in a collision.

### BACKGROUND

Vehicle air conditioning systems circulate a refrigerant through air conditioning lines, a compressor, an evaporator and other components of the air conditioning system. Prior art systems circulated Freon®, non-flamable refrigerants, R134a, CO₂, or other types of refrigerants.

Global warming potential (GWP) refrigerants are proposed for use in vehicle HVAC systems that are flammable if exposed to an ignition source with the concentration of the refrigerant within the flammability limits of the GWP refrigerant. The pressure within the HVAC system can expel refrigerant in the engine compartment if the system is compromised in a collision.

This disclosure is directed to the above problems and other problems as summarized below.

### SUMMARY

According to one aspect of this disclosure, a fire suppression system is provided for an HVAC system for a vehicle. The fire suppression system comprises a refrigerant circulation loop that circulates a flammable refrigerant. A pressure sensor is operatively connected to the circulation loop to sense a reduction in pressure within the loop. A collision sensor is operatively connected to the vehicle to sense the occurrence of a collision. A controller receives a pressure signal from the pressure sensor and a collision signal from the collision sensor. The controller actuates the fire suppression composition distribution system to dispense the fire suppression composition in response to the pressure signal and the collision signal.

According to other aspects of the fire suppression system an optional temperature sensor on the vehicle provides a temperature signal to the controller in addition to the pressure signal and the collision signal before actuating the fire suppression system. The temperature sensor may be an engine coolant temperature sensor or an exhaust gas temperature sensor.

Alternatively, the fire suppression system may include an optional engine load calculating system that receives operating data from the vehicle and calculates a load value representing engine load. The controller receives the engine load value in addition to the pressure signal and the collision signal before actuating the fire suppression system.

The pressure sensor may be an air conditioning pressure switch signal that detects a reduction in the pressure in the circulation loop and sends the pressure signal to the controller. The collision sensor may be a restraints control module that detects a collision and sends the pressure signal to the controller. The collision sensor may be an accelerometer in the restraints control module.

The fire suppression system may include a distribution system that contains the fire suppression composition under pressure, and includes at least one nozzle for dispensing the fire suppression composition in an engine compartment of the vehicle. The fire suppression composition may be a fire retardant chemical, nitrogen gas (N₂), or an inert gas.

According to another aspect of this disclosure a method is disclosed for suppressing an engine compartment fire in a vehicle having an HVAC system circulating a flammable refrigerant. The method includes the steps of sensing a pressure value in the HVAC system and providing a pressure signal, sensing a vehicle collision and providing a collision signal. The pressure signal and collision signal are received at a controller and a fire suppressant is discharged into the engine compartment when the rate of change of the pressure signal is below a predetermined rate of change of the pressure value. The rate of change is monitored to avoid discharge of the fire suppression composition if there is only a slow leak.

According to other aspects of the method, a temperature sensor on the vehicle provides a temperature signal in addition to the pressure signal and the collision signal before discharging the fire suppressant. The temperature sensor may be an engine coolant temperature sensor or an exhaust gas temperature sensor.

The method may include the step of calculating an engine load value based upon operating data received from the vehicle. The controller receives the engine load value and compares the engine load value to a predetermined engine load value before discharging the fire suppressant.

The discharging step may further comprise dispensing the fire suppressant through at least one nozzle in an engine compartment of the vehicle. The fire suppressant is a fire retardant chemical or an inert gas.

The aspects of this disclosure as summarized above and other aspects will be described below in greater detail with reference to the attached drawings.

### BRIEF DESCRIPTION OF THE DRAWINGS

FIG. 1 is a top plan view of a vehicle in phantom lines that illustrates one example of the disclosed fire suppression system.

FIG. 2 is a flowchart of one embodiment of an algorithm for the fire suppressant system.

FIG. 3 is a flowchart of another embodiment of an algorithm for the fire suppressant system.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

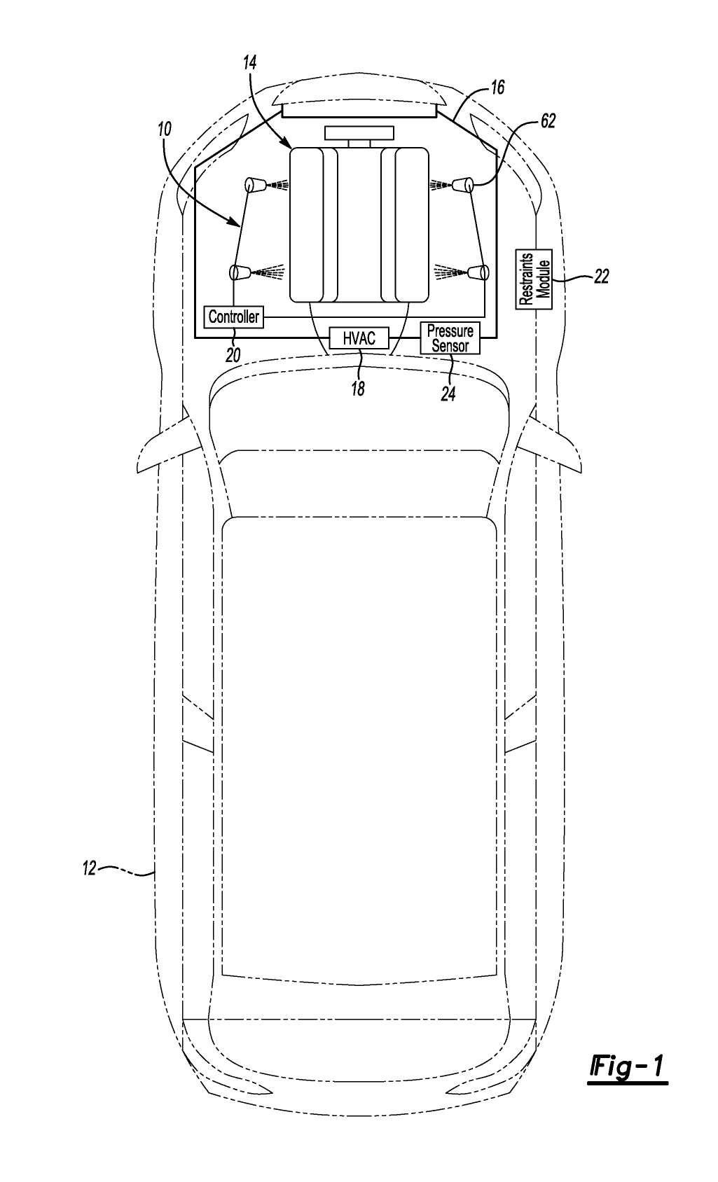

Referring to FIG. 1, a fire suppression system 10 is shown installed on a vehicle 12. The fire suppression system 10 is disposed in the engine compartment 14 of the vehicle 12. A refrigeration circulation loop 16 is part of a heating ventilation and air conditioning (HVAC) system 18. The HVAC system 18 circulates a refrigerant through the refrigerant circulation loop 16. The HVAC system 18 condenses and evaporates and contains the refrigerant as is well known in the art. A controller 20 may be a stand-alone controller 20 or incorporated in the engine control module or other controller on the vehicle 12. The controller 20 receives signals from a restraints module 22.

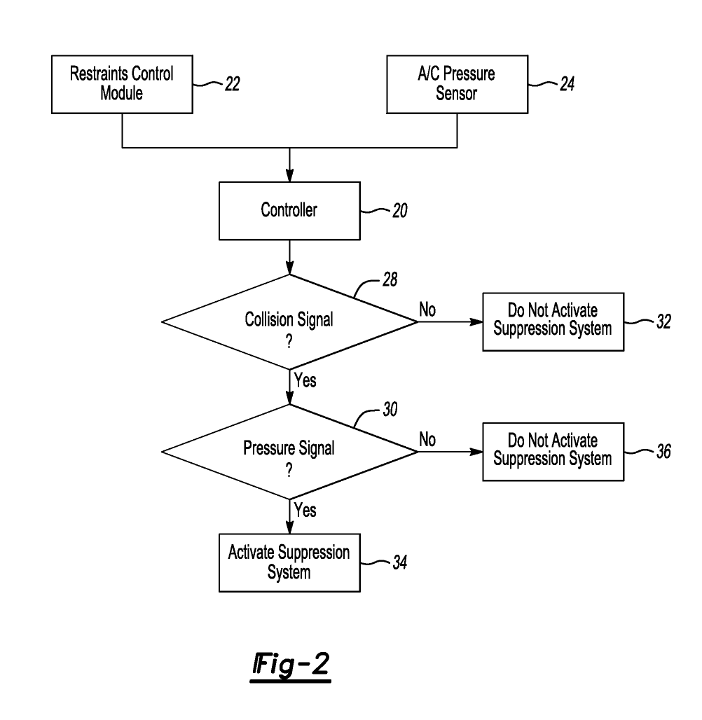

Referring to FIGS. 1 and 2, the HVAC system 18 includes an air conditioning (A/C) pressure sensor 24. The A/C pressure sensor 24 may be a pressure sensor that is used to detect high pressure conditions in the HVAC system 18. The A/C pressure sensor 24 may be used to also provide a signal to the controller 20 indicating that the refrigeration circulation loop 16 is ruptured or compromised resulting in a rapid loss of pressure. A restraints control module 22 may provide a collision signal to the controller 20. The A/C pressure sensor 24 may provide a pressure signal to the controller 20. The collision signal is evaluated at 28. If a collision signal is received from the restraints control module 22, the controller then looks at 30 to determine whether a pressure signal indicating a rapid reduction in pressure is received from the A/C pressure sensor 24. If no collision signal is received from the restraints control module 22, the controller, at 32, directs the fire suppression system 10 and does not activate the suppression system.

If the collision signal is indicated to be received at 28, the controller 20 looks to the pressure signal at 30 and if the pressure signal is received at 30 indicating a rapid loss of pressure from the A/C pressure sensor 24, the controller 20 activates the suppression system at 34. If no pressure signal is received at 30, the controller does not activate the suppression system at 36.

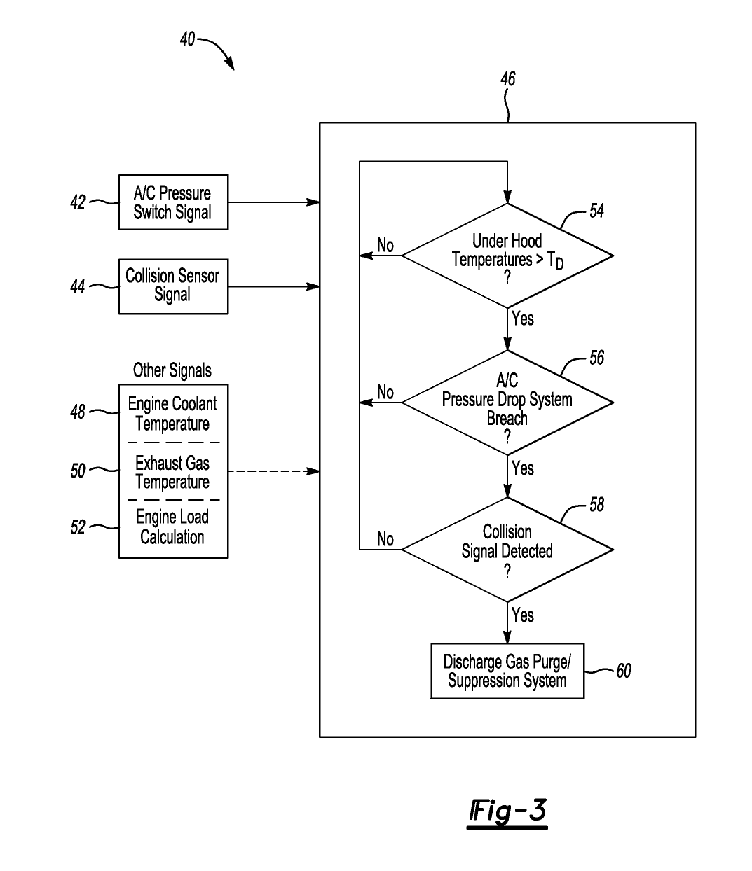

Referring to FIG. 3, an alternative embodiment is disclosed in the form of a fire suppression system algorithm 40. The fire suppression system algorithm 40 may receive an A/C pressure switch signal at 42. A crash sensor signal is provided at 44 to a controller indicated by the box 46. The controller evaluates the A/C pressure switch signal 42 and the collision sensor signal 44 as illustrated by the flowchart within the controller 46. Other signals may also be incorporated and evaluated by the system. In particular, a temperature signal may be measured at 48 by measuring the engine coolant temperature. Alternatively, a temperature may be inferred from an exhaust gas temperature at 50. Based upon the engine coolant exhaust gas temperature, the controller 46 may determine whether the temperature within the engine compartment 14 is sufficient to ignite the flammable refrigerant circulating through the refrigerant circulation loop 16 (shown in FIG. 1).

Alternatively, an engine load calculation 52 may be developed based upon data provided from the engine control module or other source of data representative of the engine load. From the engine load calculation 52, the controller 46 can infer temperature of the engine compartment 14.

The controller 46 evaluates the under-hood temperature at 54 to determine whether the under-hood temperature is greater than a predetermined temperature T_{D}. If the temperature is not greater than T_{D}, the controller 46 continues to monitor the system. If the under-hood temperatures are greater than T_{D}, the controller then evaluates at 56 whether the rapid reduction in pressure in the air conditioning system indicates that the system is breached. If the air conditioning system is breached, refrigerant may be released from the refrigerant recirculation loop 16 (shown in FIG. 1). The controller then determines at 58 whether a collision signal was detected as indicated by receiving a signal from the crash sensor signals. If so, the controller 46 actuates the fire suppression system at 60. Depending upon the type of fire suppression system, a gas, such as nitrogen (N₂) or an inert gas may be dispensed within the engine compartment 14. If the fire suppression system dispenses a fire retardant, the fire retardant may be sprayed through nozzle 62 (shown in FIG. 1). As used herein, the term fire suppression composition should be understood and interpreted to refer to either a gas purge or fire retardant dispensing fire suppression system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A fire suppression system for a vehicle comprising:
a circulation loop that circulates a flammable refrigerant;
a pressure sensor operatively connected to the circulation loop to sense a reduction in pressure;
a collision sensor operatively connected to the vehicle to sense a collision;
a distribution system dispenses a fire suppression composition; and
a controller receives a pressure signal from the pressure sensor and a collision signal from the collision sensor, and actuates the distribution system.

2. The fire suppression system of claim 1 further comprising:
a temperature sensor disposed on the vehicle; and
wherein the controller receives a temperature signal in addition to the pressure signal and the collision signal before actuating the fire suppression system.

3. The fire suppression system of claim 2 wherein the temperature sensor is an engine coolant temperature sensor.

4. The fire suppression system of claim 2 wherein the temperature sensor is an exhaust gas temperature sensor.

5. The fire suppression system of claim 1 further comprising:
an engine load calculating system that receives operating data from the vehicle and calculates a load value representing engine load; and
wherein the controller receives the engine load value in addition to the pressure signal and the collision signal before actuating the fire suppression system.

6. The fire suppression system of claim 1 wherein the pressure sensor is an air conditioning pressure switch that detects a reduction in the pressure in the circulation loop and sends the pressure signal to the controller.

7. The fire suppression system of claim 1 wherein the collision sensor is a restraints control module that detects a collision and sends the pressure signal to the controller.

8. The fire suppression system of claim 7 wherein the collision sensor is an accelerometer in the restraints control module.

9. The fire suppression system of claim 1 wherein the distribution system contains the fire suppression composition under pressure, and includes at least one nozzle for dispensing the fire suppression composition in an engine compartment of the vehicle.

10. The fire suppression system of claim 1 wherein the fire suppression composition is a fire retardant chemical.

11. The fire suppression system of claim 1 wherein the fire suppression composition is an inert gas.

12. The fire suppression system of claim 1 wherein the fire suppression composition is nitrogen gas.

13. A method of suppressing a fire in a vehicle, comprising:
sensing a pressure value in an HVAC system and providing a pressure signal;
sensing a vehicle collision and providing a collision signal;
receiving the pressure signal and collision signal at a controller; and
discharging a fire suppressant into an engine compartment when the rate of change of the pressure signal is above a predetermined rate of change of the pressure value.

14. The method of claim 13 further comprising:
providing a temperature sensor on the vehicle; and
wherein the controller receives a temperature signal in addition to the pressure signal and the collision signal before discharging the fire suppressant.

15. The method of claim 14 wherein the temperature sensor is an engine coolant temperature sensor.

16. The method of claim 14 wherein the temperature sensor is an exhaust gas temperature sensor.

17. The method of claim 13 further comprising:
calculating an engine load value based upon operating data received from the vehicle; and
wherein the controller receives the engine load value and compares the engine load value to a predetermined engine load value before discharging the fire suppressant.

18. The method of claim 13 wherein the discharging step further comprises dispensing the fire suppressant through at least one nozzle in an engine compartment of the vehicle.

19. The method of claim 13 wherein the fire suppressant is a fire retardant chemical.

20. The method of claim 13 wherein the fire suppressant is an inert gas.
